(19) United States
(12) Patent Application Publication
(10) Pub. No.: US 2026/0237222 A1
(43) Pub. Date: Aug. 13, 2026

(54) MOVING-BODY DETECTION DEVICE, SYSTEM, METHOD, AND NON-TRANSITORY COMPUTER READABLE MEDIUM STORING PROGRAM

(71) Applicant: NEC Corporation, Tokyo (JP)

(72) Inventors: Masahito SAKAI, Tokyo (JP); Kosuke TONO, Tokyo (JP); Daisuke MORI, Tokyo (JP); Hisahiro OBA, Tokyo (JP)

(73) Assignee: NEC Corporation, Tokyo (JP)

(21) Appl. No.: 19/156,057

(22) PCT Filed: Feb. 21, 2023
(86) PCT No.: PCT/JP2023/006196

§ 371 Date: Aug. 13, 2025

(51) Int. Cl. G06V 20/58; G06T 7/215; G06V 20/54

(52) U.S. Cl. CPC G06V 20/58; G06T 7/215; G06V 20/54; G06T 2207/10016; G06T 2207/30196; G06T 2207/30252

(57) ABSTRACT

A mobile object detection device comprises: an acquisition unit for acquiring video including a plurality of frames captured; a detection unit for detecting a mobile object from each of the plurality of frames on the basis of a threshold value of a prescribed mobile object detection score; and an adjustment unit that, if a mobile object is detected from at least one frame among the plurality of frames, causes the detection unit to detect the mobile object in at least one frame of a frame before and a frame after the frame where the mobile object was detected, in a state where the threshold value for the mobile object detection score in a region corresponding to a region where the mobile object was detected has been lowered below the threshold value of the prescribed mobile object detection score, in the at least one frame.

### TECHNICAL FIELD

The present disclosure relates to a moving-body detection device, system, method, and a non-transitory computer readable medium storing a program.

### BACKGROUND ART

In a case where a moving body such as a person is included in a video imaged by an in-vehicle camera or the like during traveling of a vehicle, there is a case where it is necessary to blur the moving body, from the viewpoint of personal information protection. In order to blur the moving body included in the video, it is required to accurately detect the moving body from the imaged video.

PTL 1 discloses a technique for detecting a person from a video obtained by imaging surroundings of a vehicle at the time during the vehicle is traveling.

### CITATION LIST

### Patent Literature

### PTL 1: JP 2022-042238 A

### SUMMARY OF INVENTION

### Technical Problem

If erroneous detection occurs in a case where a moving body is detected from a video, there is a possibility that blurring occurs in a region where there is no moving body in the video, that is, blurring is not needed. Therefore, it is required to improve detection accuracy of the moving body included in the video.

The present disclosure has been made to solve such a problem, and an object of the present disclosure is to provide a moving-body detection device, system, method, and a non-transitory computer readable medium that stores a program that can accurately detect a moving body.

### Solution to Problem

A moving-body detection device according to the present disclosure includes
an acquisition unit for acquiring a video including a plurality of frames imaged by a predetermined imaging apparatus provided in a vehicle,
a detection unit for detecting a moving body from each of the plurality of frames based on a threshold of a predetermined moving body detection score, and
an adjustment unit for causing the detection unit to detect a moving body in at least one frame, in a state where a threshold of a moving body detection score in a region related to a region in which the moving body is detected is lowered below the threshold of the predetermined moving body detection score, in the at least one of frames before and after a frame in which the moving body is detected, in a case where the moving body is detected from at least one of the plurality of frames.

A moving-body detection system according to the present disclosure includes
an imaging apparatus that is provided in a vehicle and images a video around the vehicle and
a moving-body detection device communicable with the imaging apparatus, in which
the moving-body detection device includes
an acquisition unit that acquires a video including a plurality of frames imaged by the imaging apparatus,
a detection unit that detects a moving body from each of the plurality of frames based on a threshold of a predetermined moving body detection score, and
an adjustment unit that causes the detection unit to detect a moving body in at least one frame, in a state where a threshold of a moving body detection score in a region related to a region in which the moving body is detected is lowered below the threshold of the predetermined moving body detection score, in the at least one of frames before and after a frame in which the moving body is detected, in a case where the moving body is detected from at least one of the plurality of frames.

A moving-body detection method according to the present disclosure performed by a computer, includes
a process for acquiring a video including a plurality of frames imaged by a predetermined imaging apparatus provided in a vehicle,
a process for detecting a moving body from each of the plurality of frames based on a threshold of a predetermined moving body detection score, and
a process for detecting a moving body in at least one frame, in a state where a threshold of a moving body detection score in a region related to a region in which the moving body is detected is lowered below the threshold of the predetermined moving body detection score, in the at least one of frames before and after a frame in which the moving body is detected, in a case where moving body is detected from at least one of the plurality of frames.

A non-transitory computer readable medium according to the present disclosure stores a moving-body detection program for causing a computer to execute processing including
processing for acquiring a video including a plurality of frames imaged by a predetermined imaging apparatus provided in a vehicle,
processing for detecting a moving body from each of the plurality of frames based on a threshold of a predetermined moving body detection score, and
processing for detecting a moving body in at least one frame, in a state where a threshold of a moving body detection score in a region related to a region in which the moving body is detected is lowered below the threshold of the predetermined moving body detection score, in the at least one of frames before and after a frame in which the moving body is detected, in a case where moving body is detected from at least one of the plurality of frames.

### Advantageous Effects of Invention

According to the present disclosure, it is possible to provide a moving-body detection device, system, method, and a non-transitory computer readable medium storing a program that can accurately detect a moving body.

### BRIEF DESCRIPTION OF DRAWINGS

FIG. 1 is a block diagram illustrating a configuration of a moving-body detection device according to a first example embodiment.

FIG. 2 is a flowchart illustrating a flow of a moving-body detection method according to the first example embodiment.

FIG. 3 is a block diagram illustrating a configuration of a moving-body detection system according to a second example embodiment.

FIG. 4 is a block diagram illustrating a configuration of a moving-body detection device according to the second example embodiment.

FIG. 5 is an example of a frame including a moving body.

FIG. 6 is another example of the frame including the moving body.

FIG. 7 is a diagram illustrating an example of a frame in which the moving body is detected.

FIG. 8 is a flowchart illustrating a flow of a moving-body detection method according to the second example embodiment.

FIG. 9 is an example of the frame including the plurality of moving bodies.

FIG. 10 is a block diagram illustrating a configuration of a moving-body detection device according to a third example embodiment.

FIG. 11 is a diagram illustrating an example of a frame in which a movement destination of a moving body is estimated.

FIG. 12 is a flowchart illustrating a flow of a moving-body detection method according to the third example embodiment.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description.

### First Example Embodiment

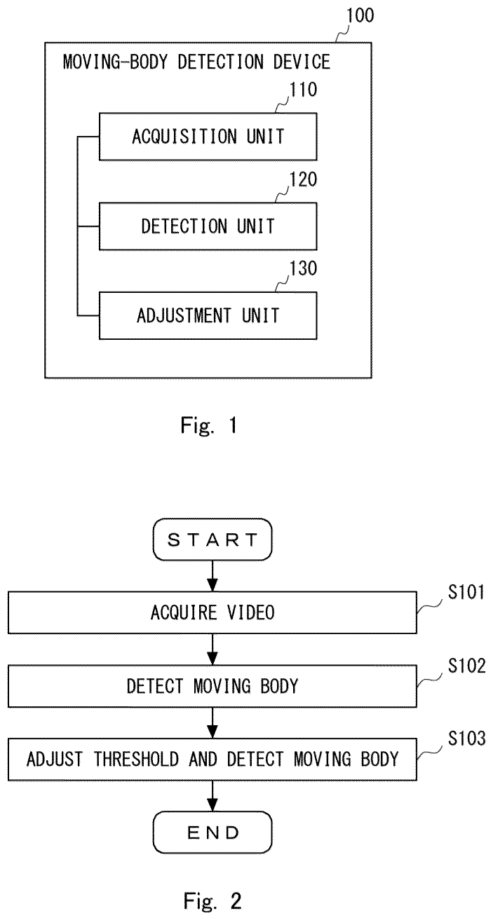

FIG. 1 is a block diagram illustrating a configuration of a moving-body detection device 100 according to a first example embodiment. The moving-body detection device 100 includes an acquisition unit 110, a detection unit 120, and an adjustment unit 130. The moving-body detection device 100 is connected to a network 500 (not illustrated), and the network 500 may be a wired or wireless network. An imaging apparatus 300 or the like (not illustrated) is connected to the network 500. The imaging apparatus 300 is an apparatus that is provided in a vehicle 310 (not illustrated) and images surroundings of the vehicle. The video imaged by the imaging apparatus 300 is a moving image and includes a plurality of consecutive frames.

The acquisition unit 110 acquires the video imaged by the imaging apparatus 300 provided in the vehicle 310. It is assumed that the video include a plurality of frames. The detection unit 120 detects a moving body from the plurality of frames included in the video acquired by the acquisition unit 110, based on a threshold of a predetermined moving body detection score. The moving body detection score is a numerical value calculated for each region in the frame. The numerical value of the moving body detection score in a region with a high possibility that the moving body exists is higher than that in other regions. Note that a method for calculating the moving body detection score is not particularly limited, and other existing techniques can be applied. The threshold of the predetermined moving body detection score (hereinafter, may be referred to as “threshold”) is a preset numerical value and is used in a case where the moving body is detected from the frame included in the video. The threshold may be set to a value different according to a region in the frame. In a case where the moving body detection score in the region in the frame is equal to or more than the threshold in the region, the detection unit 120 determines that a moving body exists in the region. The moving body moves on a road and is, for example, a person, an automobile, a motorcycle, an electric scooter, or the like.

The plurality of frames included in the video is continuously imaged in time. Therefore, in a case where a moving body is detected in a single frame of the plurality of frames included in the video, there is a high possibility that the moving body is detected in frames before and after the frame. In a case where the threshold of the moving body detection score in the region is lowered, the moving body is easily detected in the region. Therefore, in a case where the detection unit 120 detects the moving body, the adjustment unit 130 performs adjustment to lower the threshold of the moving body detection score in the region with a high possibility that the moving body is imaged. Specifically, the adjustment unit 130 lowers the threshold in a region in the frame related to the region, in which the moving body is detected, in at least one of the frames before and after the frame in which the moving body is detected. The adjustment unit 130 causes the detection unit 120 to detect the moving body in at least one frame, based on the adjusted threshold of the moving body detection score.

FIG. 2 is a flowchart illustrating a flow of a moving-body detection method according to the first example embodiment. First, the acquisition unit 110 acquires a video imaged by a predetermined imaging apparatus provided in the vehicle (step S101). Next, the detection unit 120 detects the moving body from the frame included in the video based on the threshold of the predetermined moving body detection score (step S102). Next, the adjustment unit 130 adjusts the threshold of the moving body detection score and causes the detection unit 120 to detect the moving body in at least one of the frames before and after the frame in which the moving body is detected based on the adjusted threshold (step S103). Specifically, the adjustment unit 130 lowers the threshold of the moving body detection score in the region related to the region in which the moving body is detected, in at least one of the frames before and after the frame in which the moving body is detected, in a case where the moving body is detected from the video. Then, the adjustment unit 130 causes the detection unit 120 to detect the moving body in at least one frame, in a state where the threshold of the moving body detection score is lowered. In this way, since the moving-body detection method according to the present example embodiment adjusts the threshold of the moving body detection score in the frames before and after the frame, with reference to the frame in which the moving body is detected, it is possible to accurately detect the moving body.

The moving-body detection device 100 includes a processor, a memory, and a storage apparatus as components not illustrated. The storage apparatus stores a computer program in which processing of the moving-body detection method according to the present example embodiment is implemented. Then, the processor reads the computer program from the storage apparatus into the memory and executes the computer program. As a result, the processor achieves functions as the acquisition unit 110, the detection unit 120, and the adjustment unit 130.

Alternatively, each of the acquisition unit 110, the detection unit 120, and the adjustment unit 130 may be achieved by dedicated hardware. Some or all of the components of each apparatus may be achieved by a general-purpose or dedicated circuitry, a processor, or a combination thereof. These components may be configured with a single chip or may be configured with a plurality of chips connected via a bus. Some or all of the components of each apparatus may be achieved by a combination of the above-described circuitry or the like and a program. A central processing unit (CPU), a graphics processing unit (GPU), a field-programmable gate array (FPGA), or the like can be used as the processor.

In a case where some or all of the components of the moving-body detection device 100 are achieved by a plurality of information processing apparatuses, circuits, and the like, the plurality of information processing apparatuses, circuits, and the like may be disposed in a centralized manner or in a distributed manner. For example, the information processing apparatuses, the circuits, or the like may be achieved in the form of a client server system, a cloud computing system, or the like in which they are connected to each other through a communication network. A function of the moving-body detection device 100 may be provided in a Software as a Service (Saas) format.

### Second Example Embodiment

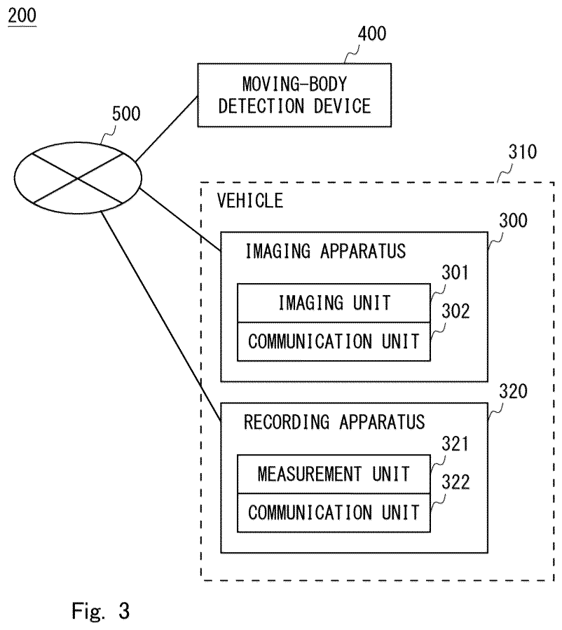

A second example embodiment is a specific example of the first example embodiment described above. FIG. 3 is a block diagram illustrating a configuration of a moving-body detection system 200 according to the second example embodiment. The moving-body detection system 200 includes at least an imaging apparatus 300 and a moving-body detection device 400 and may further include a recording apparatus 320. Each of the imaging apparatus 300 and the recording apparatus 320 is connected to the moving-body detection device 400 via a network 500. Description overlapping with the first example embodiment will be omitted as appropriate.

The moving-body detection system 200 is a system that detects a moving body from a video imaged in a vehicle 310. The vehicle 310 is, for example, an automobile and may be a vehicle other than an automobile such as a motorcycle or a bicycle. The imaging apparatus 300 and the recording apparatus 320 are provided in the vehicle 310. The imaging apparatus 300 is an apparatus that images a scene around the vehicle 310 and is, for example, a drive recorder. The imaging apparatus 300 includes an imaging unit 301 and a communication unit 302. The imaging unit 301 is a camera. The imaging unit 301 images, for example, a scene in front of the vehicle 310, that is, a scene that a driver sitting on a driver's seat of the vehicle 310 can see. The communication unit 302 is a communication interface with the network 500. The communication unit 302 transmits the video imaged by the imaging unit 301 to the moving-body detection device 400 via the network 500.

The recording apparatus 320 is an apparatus that records a traveling speed of the vehicle 310. The recording apparatus 320 includes a measurement unit 321 and a communication unit 322. The measurement unit 321 measures the traveling speed of the vehicle 310. The communication unit 322 is a communication interface with the network 500. The communication unit 322 transmits speed information including a speed measured by the measurement unit 321 to the moving-body detection device 400 via the network 500.

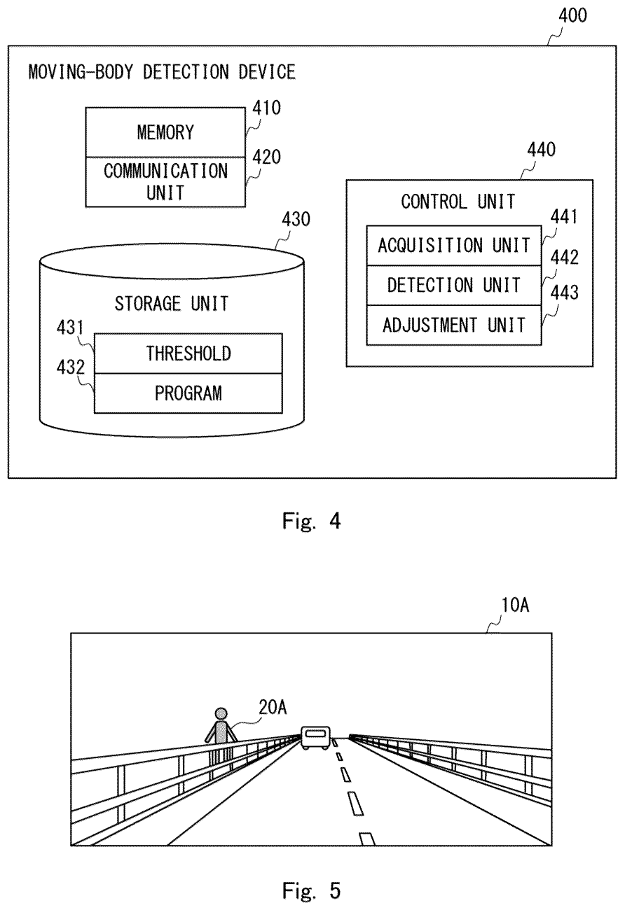

Next, a configuration of the moving-body detection device 400 will be described in detail, with reference to FIG. 4. FIG. 4 is a block diagram illustrating the configuration of the moving-body detection device 400. The moving-body detection device 400 includes a memory 410, a communication unit 420, a storage unit 430, and a control unit 440.

The memory 410 is a storage region for temporarily storing processing contents of the control unit 440, and is, for example, a volatile storage device such as a random access memory (RAM). The communication unit 420 is an interface that communicates with outside of the moving-body detection device 400. The storage unit 430 is a storage apparatus that stores a threshold 431, a program 432, or the like. The threshold 431 is a numerical value used in a case where a moving body is detected based on a moving body detection score and may be set to a value different according to a region in a frame. The program 432 is a computer program in which moving body detection processing according to the present example embodiment is implemented.

The control unit 440 includes an acquisition unit 441, a detection unit 442, and an adjustment unit 443. The control unit 440 is a control apparatus that controls an operation of the moving-body detection device 400 and is, for example, a processor such as a CPU. The control unit 440 reads the program 432 from the storage unit 430 into the memory 410 and executes the program 432.

As a result, the control unit 440 achieves functions as the acquisition unit 441, the detection unit 442, and the adjustment unit 443.

The acquisition unit 441 acquires the video transmitted from the imaging apparatus 300. The video includes a plurality of consecutive frames. In addition, the video may include identification information, time information, or the like. The identification information is information for identifying the vehicle 310 in which the imaging apparatus 300 that images the video is provided. The time information is information regarding a time during the video is imaged. Moreover, the acquisition unit 441 may acquire the speed information transmitted from the recording apparatus 320. It is assumed that the speed information include at least information regarding the traveling speed of the vehicle 310 and may further include identification information and time information. The time information included in the speed information is information regarding a time during the traveling speed is recorded.

The detection unit 442 detects a moving body, from the video acquired by the acquisition unit 441. Specifically, the detection unit 442 calculates a moving body detection score, for each frame included in the video acquired by the acquisition unit 441. Next, the detection unit 442 determines whether the moving body detection score is equal to or less than the threshold 431. The detection unit 442 calculates and determines the moving body detection score for each of the plurality of frames. The threshold 431 is a preset numerical value used in a case where the moving body is detected based on the moving body detection score and may be set to a value different according to a region in a frame. The detection unit 442 determines that the moving body is imaged in a portion where the moving body detection score is equal to or more than the threshold, in the frame.

FIG. 5 is an example of a frame including a moving body. A frame 10A illustrated in FIG. 5 is the frame included in the video acquired by the acquisition unit 441. As illustrated in FIG. 5, in a case where a moving body 20A exists in the frame 10A, a moving body detection score near the moving body 20A is calculated to be lower than other regions. In a case where the moving body detection score near the moving body 20A, that is, in a region 30A is equal to or more than a threshold, the detection unit 442 determines that the moving body is imaged in the region 30A.

Returning to FIG. 4, the description will be continued.

Hereinafter, “frame in which moving body is detected” may be referred to as “detected frame”. In addition, “at least one of frames before and after frame in which moving body is detected” may be referred to as “front-rear frame”. In a case where the detection unit 442 detects the moving body, the adjustment unit 443 adjusts a threshold in the front-rear frame. The detection unit 442 detects the moving body in the front-rear frame, based on the threshold adjusted by the adjustment unit 443.

For example, in a case where the detection unit 442 detects a moving body in a single frame while proceeding the detection of the moving body in the plurality of frames included in the video, the adjustment unit 130 adjusts the threshold of the moving body detection score and causes the detection unit 442 to detect the moving body in the front-rear frame based on the adjusted threshold. There is a high possibility that the moving body is imaged, in the frames before and after the frame in which the moving body is detected. Therefore, the adjustment unit 443 determines a range of a region in the front-rear frame related to the region in which the moving body is detected in the detected frame, that is, a range of a region in which the threshold of the moving body detection score is lowered. Hereinafter, “region in which moving body is detected in detected frame” may be referred to as “detected region”. In addition, “region in front-rear frame related to region in which moving body is detected in detected frame” may be referred to as “related region”. The adjustment unit 443 lowers the threshold of the moving body detection score in the related region in the front-rear frame and causes the detection unit 442 to detect the moving body in the front-rear frame.

A method for determining the range of the related region by the adjustment unit 443 is not particularly limited, and for example, a range same as the detected region may be determined as the related region. The control unit 440 may determine a region that covers the entire detected region and is wider than the detected region, as the related region. The control unit 440 may determine the related region, based on the detected region and the speed information of the vehicle 310. Hereinafter, a case where the related region is determined based on the detected region and the speed information of the vehicle 310 will be described in detail, with reference to FIGS. 5 to 7.

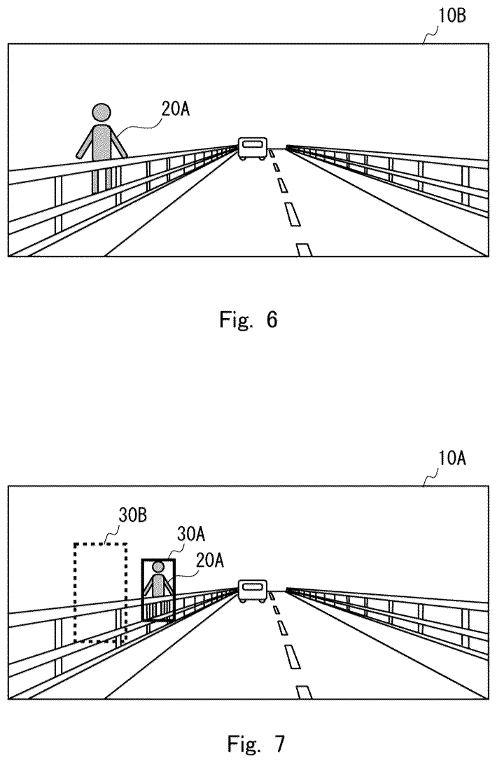

The frame 10A illustrated in FIG. 5 and a frame 10B illustrated in FIG. 6 are examples of each frame included in the video imaged by the imaging apparatus 300. It is assumed that the frames 10A and 10B be imaged during the vehicle 310 travels forward on a road and the moving body (person) 20A exist on a left side of the road and in front of the vehicle 310. It is assumed that the frame 10B be a frame imaged after the frame 10A. Since the vehicle 310 travels forward, the moving body 20A gradually approaches the vehicle 310. Therefore, in the frame 10B, the moving body 20A is imaged at a left end in the frame, as compared with the frame 10A. In a case where the traveling speed of the vehicle 310 is high, the moving body 20A approaches the vehicle 310 faster than a case where the traveling speed is low. Therefore, in a case where the traveling speed of the vehicle 310 is high, the region in which the moving body 20A is imaged is on the left side in the frame 10B, as compared with a case where the traveling speed is low.

Hereinafter, an operation of each unit in a case where the detection unit 442 detects a moving body in order of imaging time of each frame included in the video and detects the moving body in the frame 10A will be described, with reference to FIG. 7. FIG. 7 is a diagram illustrating an example of a frame in which a moving body is detected. In the following example, it is assumed that the acquisition unit 441 acquire a video including the time information from the imaging apparatus 300 and acquire the speed information including the time information from the recording apparatus 320. It is assumed that the adjustment unit 443 can estimate the traveling speed of the vehicle 310 at the time during each frame included in the video is imaged, by comparing the time information included in the video with the time information included in the speed information.

In a case where the detection unit 442 detects the moving body 20A in the region 30A in the frame 10A, the adjustment unit 443 estimates a region 30B with a high possibility that the moving body 20A is imaged in the frame 10B, based on the traveling speed of the vehicle 310 at the time during the frame 10A is imaged and a position of the region 30A in the frame 10A. Specifically, since the region 30A exists on the left side of a center line of the frame 10A, the adjustment unit 443 sets the region 30B on the left side of the region 30A. In a case where the traveling speed of the vehicle 310 is high, the adjustment unit 443 sets the region 30B on the left side of the frame 10B, as compared with a case where the traveling speed is low.

Next, the adjustment unit 443 lowers the threshold of the moving body detection score in the region 30B and causes the detection unit 442 to detect a moving body in the frame 10B. In this way, the moving-body detection device 400 according to the present example embodiment detects the moving body in a state where the threshold of the region 30B having a high possibility that the moving body 20A is imaged is lowered, in the frame 10B after the frame 10A in which the moving body 20A is detected. Therefore, the moving-body detection device 400 can accurately detect the moving body from the video.

In the examples illustrated in FIGS. 5 to 7, in a case where the moving body 20A is detected in the frame 10B, the adjustment unit 443 may estimate a region with a high possibility that the moving body 20A is imaged in a frame (not illustrated) after the frame 10B. Then, the adjustment unit 443 may cause the detection unit 442 to detect the moving body in the frame, in a state where the threshold in the region with the high possibility that the moving body 20A is imaged in the frame after the frame 10B is set to be lower than the preset threshold 431. In this way, by detecting the moving body while adjusting the threshold each time in a case where the moving body is detected, the moving-body detection device 400 can more accurately detect the moving body.

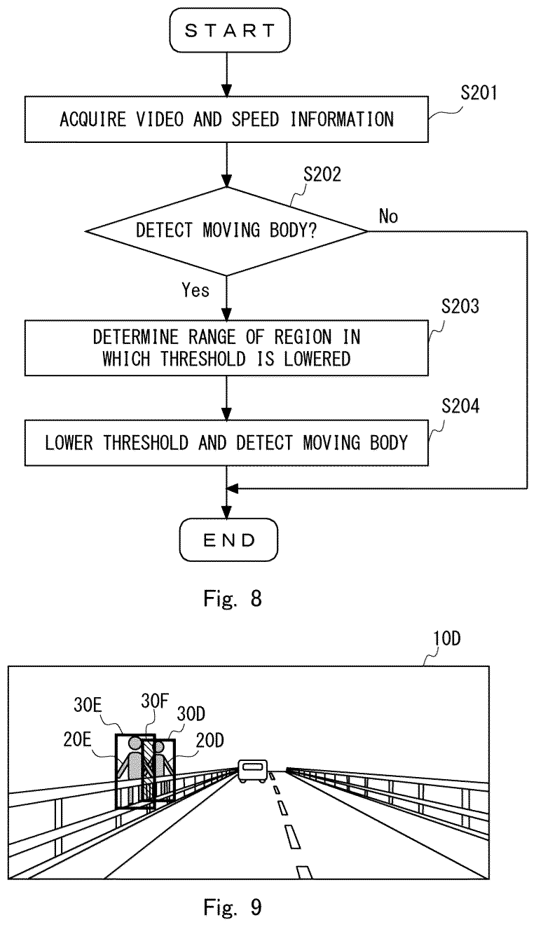

Next, an operation of the moving-body detection device 400 at the time of moving body detection will be described, with reference to FIG. 8. FIG. 8 is a flowchart illustrating a flow of moving-body detection processing. In the example illustrated in FIG. 8, a case will be described where a region in which the threshold of the moving body detection score is lowered is determined based on the region in which the moving body is detected and the speed information of the vehicle 310.

First, the acquisition unit 441 acquires the video including the time information from the imaging apparatus 300 and acquires the speed information including the time information from the recording apparatus 320 (step S201).

Next, the detection unit 442 detects the moving body based on the preset threshold 431 for each frame included in the video acquired in step S201 (step S202). In a case where the moving body is not detected in any one of the plurality of frames included in the video (step S202, No), the detection of the moving body ends. In a case where the moving body is detected in any one frame (step S202, Yes), the adjustment unit 443 determines the region in which the threshold of the moving body detection score is lowered in the front-rear frame (step S203). In step S203, the adjustment unit 443 determines the region in which the threshold of the moving body detection score is lowered in the front-rear frame, based on the position of the region in which the moving body is detected in the frame and the traveling speed of the vehicle 310 at the time during the frame is imaged. Next, the adjustment unit 443 causes the detection unit 442 to detect the moving body in the front-rear frame, based on the threshold of the moving body detection score adjusted in step S203 (step S204).

In this way, since the moving-body detection device 400 according to the present example embodiment lowers the threshold of the moving body detection score in the region with the high possibility that the moving body is imaged and detects the moving body, it is possible to accurately detect the moving body. In a case where the moving body is detected in step S204, the adjustment unit 443 may adjust the threshold and cause the detection unit 442 to detect the moving body, at least one of the frames before and after the frame in which the moving body is detected in step S204. In this case, the adjustment unit 443 estimates the region with the high possibility that the moving body is imaged, in at least one of the frames before and after the frame in which the moving body is detected in step S204, based on the position of the detected moving body or the like. Then, the detection unit 442 is caused to detect the moving body in the frame, by lowering the threshold of the moving body detection score in the region. In this way, by detecting the moving body while adjusting the threshold each time in a case where the moving body is detected, the moving-body detection device 400 can more accurately detect the moving body.

Next, an operation example of the moving-body detection device 400 in a case where a plurality of moving bodies is imaged in a frame will be described, with reference to FIG. 9. FIG. 9 is an example of a frame including a plurality of moving bodies. In a frame 10D illustrated in FIG. 9, two moving bodies 20D and 20E are imaged. In a case of detecting two or more regions in which the moving body detection score is equal to or less than a threshold are detected in the frame, the detection unit 442 determines that the moving body is imaged in each region. In the example illustrated in FIG. 9, the detection unit 442 determines that the moving body is imaged in each of regions 30D and 30E. As illustrated in FIG. 9, the plurality of moving bodies 20D and 20E may overlap and be imaged in the frame 10D, that is, the regions 30D and 30E may overlap. There is a high possibility that the moving body is imaged in a region in the front-rear frame related to the region in which the two or more moving bodies overlap. Therefore, in such a case, the adjustment unit 443 may lower the moving body detection score in a region in the front-rear frame related to a region 30F in which the two or more regions 30D and 30E overlap. In this way, the moving-body detection device 400 can more accurately detect the moving body, by lowering the threshold of the moving body detection score in the region in which the moving bodies overlap and detecting the moving body.

### Third Example Embodiment

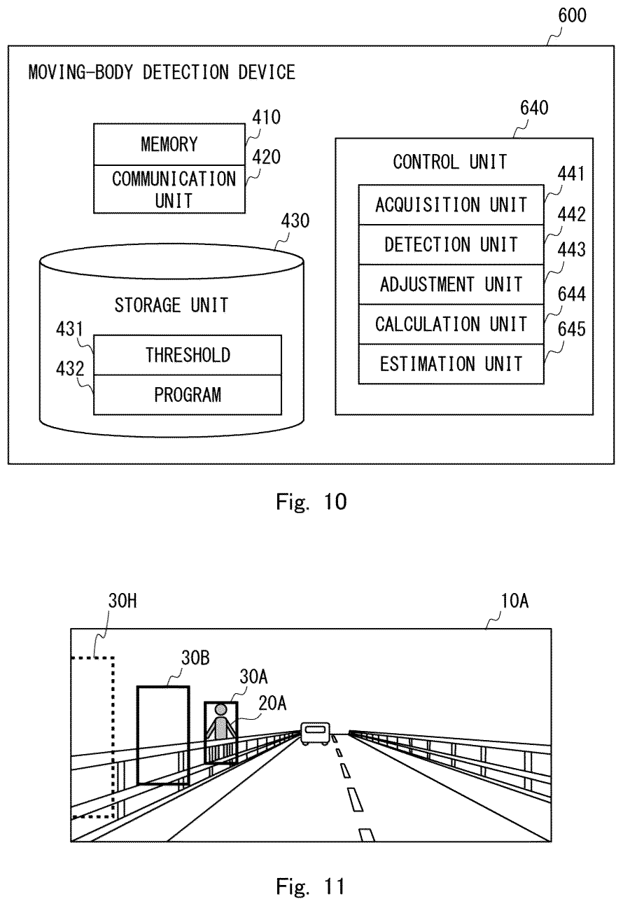

A third example embodiment is a modified example of the second example embodiment described above. In a case where a moving body is detected from two or more frames, a moving-body detection device 600 according to the present example embodiment estimates a region with a high possibility that the moving body is imaged in a front-rear frame based on a movement distance and a movement direction of the moving body between the two or more frames. FIG. 10 is a block diagram illustrating a configuration of the moving-body detection device 600 according to the third example embodiment. The moving-body detection device 600 is different from the moving-body detection device 400 illustrated in FIG. 4 in that a control unit 640 is included instead of the control unit 440. The control unit 640 includes a calculation unit 644 and an estimation unit 645, in addition to each configuration included in the control unit 440. Since other configurations overlap with those of the first or second example embodiment, the description thereof is omitted as appropriate.

The control unit 640 includes an acquisition unit 441, a detection unit 442, an adjustment unit 443, the calculation unit 644, and the estimation unit 645. The acquisition unit 441 acquires a video from an imaging apparatus 300 and may further acquire speed information from a recording apparatus 320. The detection unit 442 detects a moving body based on a threshold of a moving body detection score, for each of a plurality of frames included in the video acquired by the acquisition unit 441.

In a case where the moving body is detected from the two or more of the plurality of frames included in the video, the calculation unit 644 calculates a relative movement speed of the moving body in the video, based on the movement distance of the moving body between the two or more frames. Specifically, if the moving body is detected from the two or more frames, the calculation unit 644 calculates the movement distance of the moving body per frame, that is, the relative movement speed in the video, based on a distance between regions in which the moving body is detected.

In a case where the moving body is detected from the two or more of the plurality of frames included in the video, the estimation unit 645 estimates the movement direction of the moving body, based on the movement direction of the moving body between the two or more frames. Specifically, the estimation unit 645 estimates the movement direction of the moving body, by calculating a direction from a region in which the moving body is detected in one of the two or more frames in which the moving body is detected toward a region in which the moving body is detected in the another frame.

The adjustment unit 443 estimates a region with a high possibility that the moving body is imaged in the front-rear frame, that is, a movement destination of the moving body, based on the relative movement speed calculated by the calculation unit 644 and the movement direction estimated by the estimation unit 645. Then, the adjustment unit 443 lowers the threshold of the moving body detection score at the estimated movement destination and causes the detection unit 442 to detect the moving body.

Next, an operation example of the moving-body detection device 600 in a case where the movement destination of the moving body is estimated from the two or more frames in which the moving body is detected will be described, with reference to FIGS. 5 and 6 to 11. Hereinafter, a case will be described where a moving body 20A is detected in two adjacent frames 10A and 10B of the plurality of frames included in the video and a region with the high possibility that the moving body is imaged, that is, the movement destination of the moving body is estimated in a frame after the frame 10B. It is assumed that the frame 10B be imaged after the frame 10A.

In a case where the moving body is detected in the two frames 10A and 10B, the calculation unit 644 measures a distance between regions 30A and 30B in which the moving body is detected and calculates a distance in which the moving body moves per frame, that is, the relative movement speed of the moving body in the video. In a case where the moving body is detected in the two frames 10A and 10B, the estimation unit 645 estimates the movement direction of the moving body, by calculating a direction from the region 30A toward the region 30B. For example, as illustrated in FIGS. 5 and 6, in a case where the region 30B is positioned at the lower left of the region 30A, it is estimated that the moving body 20A moves toward the lower left.

The adjustment unit 443 estimates the region with the high possibility that the moving body is imaged, that is, the movement destination of the moving body in the frame (not illustrated) after the frame 10B, based on the relative movement speed calculated by the calculation unit 644 and the movement direction estimated by the estimation unit 645. FIG. 11 is a diagram illustrating an example of a frame in which the movement destination of the moving body is estimated. A region 30H illustrated in FIG. 11 indicates the movement destination of the moving body estimated in the frame after the frame 10B. The adjustment unit 443 estimates the region 30H based on the relative movement speed calculated by the calculation unit 644 and the movement direction estimated by the estimation unit 645, lowers the threshold of the moving body detection score in the region 30H, and causes the detection unit 442 to detect the moving body. In this way, the moving-body detection device 600 according to the present example embodiment detects the moving body in a state where the threshold of the region 30H with the high possibility that the moving body 20A is imaged is lowered, in the frame after the frames 10A and 10B in which the moving body 20A is detected. Therefore, the moving-body detection device 600 can accurately detect the moving body from the video.

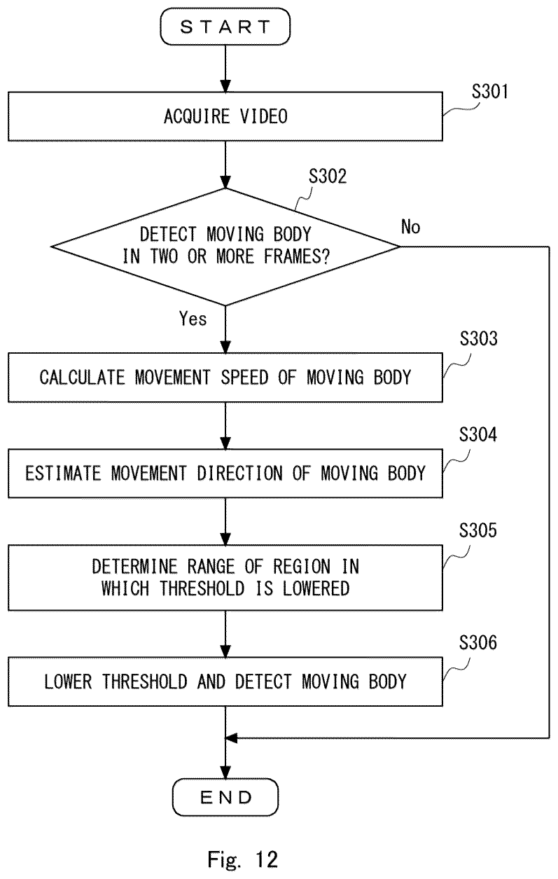

Next, an operation of the moving-body detection device 600 at the time of moving body detection will be described, with reference to FIG. 12. FIG. 12 is a flowchart illustrating a flow of moving-body detection processing. In the example illustrated in FIG. 12, a case of determining a region in which the threshold of the moving body detection score is lowered in the frame after the frame in which the moving body is detected will be described.

First, the acquisition unit 441 acquires the video from the imaging apparatus 300 (step S301). Next, the detection unit 442 detects the moving body based on a preset threshold 431 for each frame included in the video acquired in step S301 (step S302). In a case where the moving body is detected only in one or less of the plurality of frames included in the video (step S302, No), the detection of the moving body ends. In a case where the moving body is detected in two or more frames (step S302, Yes), the calculation unit 644 calculates the relative movement speed of the moving body in the video, based on the movement distance of the moving body between the two or more frames in which the moving body is detected (step S303). Next, the estimation unit 645 estimates the movement direction of the moving body, based on the movement direction of the moving body between the two or more frames in which the moving body is detected (step S304). Next, the adjustment unit 443 determines a region in which the threshold of the moving body detection score is lowered, in the front-rear frame (step S305). In step S305, the adjustment unit 443 determines a region in the front-rear frame related to the movement destination of the moving body predicted based on the relative movement speed and the movement direction of the moving body, as the region in which the threshold of the moving body detection score is lowered. Next, the adjustment unit 443 causes the detection unit 442 to detect the moving body in the front-rear frame, based on the threshold of the moving body detection score adjusted in step S305 (step S306).

In this way, since the moving-body detection device 600 according to the present example embodiment lowers the threshold of the moving body detection score in the region with the high possibility that the moving body is imaged and detects the moving body, it is possible to accurately detect the moving body. In step S302 described above, in a case where the number of frames in which the moving body is detected is 1, as in the processing described in the second example embodiment, the movement destination of the moving body may be estimated based on the speed information of the vehicle 310, and the threshold of the moving body detection score may be lowered to detect the moving body. In this case, in step S301, the acquisition unit 441 acquires the video including the time information from the imaging apparatus 300 and acquires the speed information including the time information from the recording apparatus 320. Although a case where step S303 is performed before step S304 has been described in FIG. 12, step S303 may be performed after or at the same time as step S304.

In the above-described example embodiments, the configuration of the hardware has been described, but the present disclosure is not limited thereto.

According to the present disclosure, any processing can also be achieved by causing a CPU to execute a computer program.

In the above-described example, the program can be stored using various types of non-transitory computer readable medium and supplied to a computer. The non-transitory computer readable media include various types of tangible storage media. Examples of the non-transitory computer readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and a semiconductor memory (for example, a mask ROM, a programmable ROM (PROM), an erasable PROM (EPROM), a flash ROM, or a random access memory (RAM)). The program may be supplied to the computer by various types of transitory computer readable media. Examples of transitory computer readable media include electrical signals, optical signals, and electromagnetic waves. The transitory computer readable media can supply the programs to the computer via a wired communication path such as an electric wire and an optical fiber or a wireless communication path.

The present disclosure is not limited to the above example embodiments, and can be appropriately changed without departing from the scope. The present disclosure may be implemented by appropriately combining the example embodiments.

While the present invention has been particularly shown and described with reference to example embodiments, the present invention is not limited to these example embodiments. It will be understood by those of ordinary skill in the art that various changes in form and details may be made therein without departing from the spirit and scope of the present invention as defined by the claims.

### REFERENCE SIGNS LIST

10A to 10B, 10D frame
20A, 20D to 20E moving body
30A to 30B, 30D to 30F, 30H region
100 moving-body detection device
110 acquisition unit
120 detection unit
130 adjustment unit
200 moving-body detection system
300 imaging apparatus
301 imaging unit
302 communication unit
310 vehicle
320 recording apparatus
32 measurement unit
322 communication unit
400 moving-body detection device
410 memory
420 communication unit
430 storage unit
431 threshold
432 program
440 control unit
441 acquisition unit
442 detection unit
443 adjustment unit
500 network
600 moving-body detection device
640 control unit
644 calculation unit
645 estimation unit

What is claimed is:

1. A moving-body detection device comprising:
at least one memory storing instructions, and
at least one processor configured to execute the instructions to;
acquire a video including a plurality of frames imaged by a predetermined imaging apparatus provided in a vehicle;
detect a moving body from each of the plurality of frames based on a threshold of a predetermined moving body detection score; and
cause the detection means to detect a moving body in at least one frame, in a state where a threshold of a moving body detection score in a region related to a region in which the moving body is detected is lowered below the threshold of the predetermined moving body detection score, in the at least one of frames before and after a frame in which the moving body is detected, in a case where the moving body is detected from at least one of the plurality of frames.

2. The moving-body detection device according to claim 1, wherein the at least one processor is further configured to execute the instructions to;
acquire speed information of the vehicle in which the imaging apparatus is provided, and
control the adjustment means controls a range of the region in which the threshold of the moving body detection score is lowered in the at least one frame, based on the region in which the moving body is detected and the speed information of the vehicle.

3. The moving-body detection device according to claim 1, wherein the at least one processor is further configured to execute the instructions to, in a case where a plurality of moving bodies is detected from the frame, lower the threshold of the moving body detection score in a region in the at least one frame related to a region in which two or more moving bodies are detected in an overlapping manner.

4. The moving-body detection device according to claim 1, wherein the at least one processor is further configured to execute the instructions to:
calculate a relative movement speed of a moving body in the video, based on a movement distance of the moving body between two frames, in a case where the moving body is detected from two or more of the plurality of frames;
estimate a movement direction of the moving body based on a movement direction of the moving body between the two frames; and,
lower the threshold of the moving body detection score in the region in the at least one frame related to a movement destination of the moving body predicted based on the movement speed and the movement direction.

5. The moving-body detection device according to claim 1, wherein the at least one processor is further configured to execute the instructions to, in a case where the detection means detects the moving body in the at least one frame, lower the threshold of the moving body detection score in the region related to the region in which the moving body is detected below the threshold of the predetermined moving body detection score, in the at least one of the frames before and after the at least one frame.

6.-7. (canceled)

8. A moving-body detection method performed by a computer, comprising:
acquiring a video including a plurality of frames imaged by a predetermined imaging apparatus provided in a vehicle;
detecting a moving body from each of the plurality of frames based on a threshold of a predetermined moving body detection score; and
detecting a moving body in at least one frame, in a state where a threshold of a moving body detection score in a region related to a region in which the moving body is detected is lowered below the threshold of the predetermined moving body detection score, in the at least one of frames before and after a frame in which the moving body is detected, in a case where the moving body is detected from at least one of the plurality of frames.

9. A non-transitory computer readable medium storing a moving-body detection program for causing a computer to execute processing comprising:
processing for acquiring a video including a plurality of frames imaged by a predetermined imaging apparatus provided in a vehicle;
processing for detecting a moving body from each of the plurality of frames based on a threshold of a predetermined moving body detection score; and
processing for detecting a moving body in at least one frame, in a state where a threshold of a moving body detection score in a region related to a region in which the moving body is detected is lowered below the threshold of the predetermined moving body detection score, in the at least one of frames before and after a frame in which the moving body is detected, in a case where moving body is detected from at least one of the plurality of frames.
